(19) United States
(12) Patent Application Publication
(10) Pub. No.: US 2008/0310408 A1
(43) Pub. Date: Dec. 18, 2008

(54) Internet Protocol Television

(76) Inventors: Phil Thompson, Morganville, NJ (US); J. Connon Samuel, Denver, CO (US); Jacqueline A. Totten, Bernardsville, NJ (US); Mary K. Whelan, North Caldwell, NJ (US)

Correspondence Address: FISH & RICHARDSON P.C., P.O. BOX 1022, MINNEAPOLIS, MN, 55440-1022, US

(21) Appl. No.: 11/828,962

(22) Filed: Jul. 26, 2007

Related U.S. Application Data
(60) Provisional application No. 60/943,792, filed on Jun. 13, 2007.

(51) Int. Cl. H04Q 11/00

(52) U.S. Cl. 370/386

(57) ABSTRACT

Distributing data includes establishing an asset classification for an asset or group of assets and assigning at least one of the asset classifications to a network device and another asset classification to a first set of data. The first set of data is transmitted over a network that includes the network device and is received in the network device on the condition that the asset classification assigned to the first set of data is the same as the asset classification assigned to the network device.

### CROSS-REFERENCE TO RELATED APPLICATION(S)

This application claims the priority of U.S. Provisional Patent Application No. 60/943,792, filed on Jun. 13, 2007. The disclosure of that application is incorporated herein by reference.

### BACKGROUND

This disclosure relates to Internet Protocol Television (IPTV). IPTV relates to a system where a digital television service is delivered using the Internet Protocol over a network infrastructure. For residential users, IPTV often is provided in conjunction with video services such as Video on Demand and with Internet services such as Web access and VoIP (Voice over Internet Protocol).

Typically, IPTV systems are based upon a two-tier architecture known as the “web browser” model that includes a client tier and a service tier. In the client tier, television, web pages and other data content are presented to a subscriber through a user interface screen. The subscriber interacts with the user interface to request additional data content or a new user interface screen. The request is sent to a server, e.g., a “web” or “application” server, in the service tier that sends the new data and new user interface back to the subscriber. Two-tier architectures, however, include several intrinsic problems. Due to network delays and errors, the interaction between the subscriber and the server can be slow. Accordingly, the subscriber experiences an increase in content loading times and other reductions in quality of service. Furthermore, adding subscribers to the IPTV service can require additional hardware and complex load balancing techniques to maintain satisfactory performance, which leads to an increase in costs. In addition, given that data content and user interfaces are bound together, it is difficult to provide personalized and targeted content.

### SUMMARY

The details of one or more embodiments of the invention are set forth in the description below, the accompanying drawings and in the claims. Other aspects, features and advantages of the invention will be apparent from the description, drawings and the claims.

For example, in one aspect, a method for transmitting data includes creating one or more groups of assets and establishing an asset classification for each asset or group of assets. At least one of the asset classifications is assigned to a network device. At least one asset classification also is assigned to a first set of data. The first set of data is transmitted over a network that includes the network device and is received in the network device if the asset classification assigned to the first set of data is the same as the asset classification assigned to the network device.

In another aspect, a system for distributing data includes a communication network and one or more servers coupled to the communications network, in which the one or more servers are operable to create one or more groups of assets and establish an asset classification for each asset or group of assets and a device coupled to the communications network. The device coupled to the communications network is operable to receive a first set of data transmissions over the communication network if an asset classification assigned to the first set of data transmissions is the same as an asset classification assigned to the device.

In another aspect, an article may include a machine-readable medium storing machine-executable instructions that, when applied to a machine, cause the machine to create one or more groups of assets, establish an asset classification for each asset or group of assets, assign at least one of the asset classifications to a first set of data and transmit the first set of data over a network that includes a network device. The instructions may further cause the machine to configure the network device with one of the asset classifications such that the network device receives the first set of data if the asset classification assigned to the first set of data is the same as the asset classification assigned to the network device.

Some implementations include one or more of the following features. For example, distributing data may further include selecting the first set of data from a first asset or first group of assets. The assets can include multimedia content such as television broadcasts, movies, audio broadcasts, advertisements, interactive games or communications.

In some cases, the asset includes metadata related to multimedia content, software applications configured to run on the network device, or initialization or configuration data for the network device.

In some implementations, the first set of data is transmitted as part of a multicast data transmission.

Assigning an asset classification to the network device can be based on consumer information that includes any combination of information related to consumer transactions on the network device, consumer account information, information collected from an inquiry presented to the consumer and demographic information. The asset classification of a network device may be changed based on the consumer information.

Creating one or more group of assets can include recording consumer transactions on one or more network devices and, based on the recorded consumer transactions, combining those assets into the one or more groups.

Alternatively or in addition, creation of one or more groups of assets may be based on collected demographic information or information from an inquiry presented to a consumer.

In some implementations, the first set of data can be stored in memory. In addition, the network device can receive additional data if an asset classification assigned to the additional data is the same as one or more of a plurality of asset classifications assigned to the network device. In some cases, the first set of data transmissions can be stored in memory. In addition, asset classification information, asset group information and consumer information can be stored in a database.

### BRIEF DESCRIPTION OF DRAWINGS

FIG. 1 shows an example of an internet protocol television system.

FIG. 2 is an example screen shot of a user interface control.

FIG. 3 is an example of transferring program data and requests among a management center, set-top box managers and set-top boxes.

FIG. 4 illustrates an example of sending content streams to set-top boxes.

FIG. 5 illustrates an example of sending content streams to set-top boxes.

FIG. 6 illustrates an example of adding content to broadcast streams.

FIG. 7 shows examples of set-top boxes in a house.

FIG. 8 illustrates an example of delivering content streams to set-top boxes.

FIG. 9 illustrates a block diagram of a way to deliver targeted content and advertisements.

FIG. 10 shows an example of an interactive survey displayed on a television.

FIG. 11 illustrates an example of sending messages from an event manager in a set-top box.

FIG. 12 illustrates an example of sending event markers to the subscriber management system.

FIG. 13 shows an example of assigning demographic asset groups.

FIG. 14 illustrates an example of delivering targeted content and interactive graphic overlays to set-top boxes.

FIG. 15A illustrates an example of inserting targeted advertising into content streams.

FIG. 15B illustrates a block diagram of the system.

FIG. 16 is an example of an interactive graphic overlay.

FIG. 17 illustrates an example of assigning targeted content streams.

### DETAILED DESCRIPTION

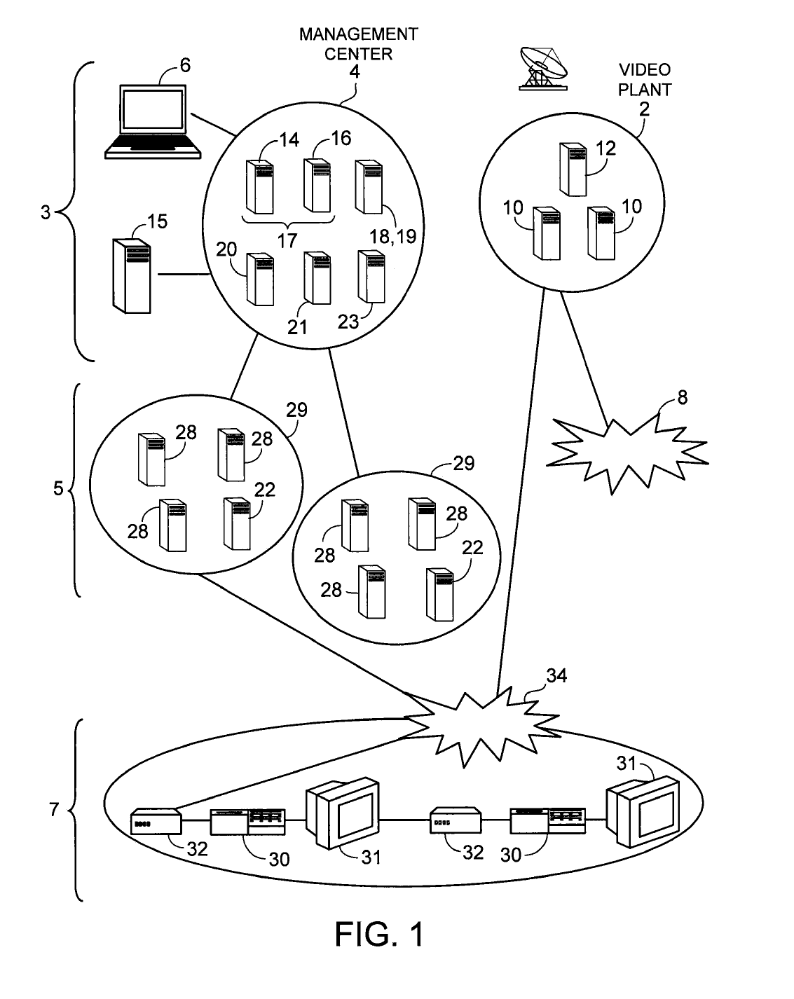

FIG. 1 illustrates an example of an IPTV system 1 that allows network operators and service providers to deliver targeted entertainment, education and advertising services such as television, movies, video-on-demand, games and voice communications to consumers by means of a set top box. The components of the system 1 will be described generally, after which a way to deliver data and content to consumers will be described in detail.

The system shown in FIG. 1 is intended to be used with any broadband network including, for example, networks based on digital subscriber line (DSL) loops, optical fiber, coaxial, and wireless transmissions in local or wide area networks. In addition, the system components may be arranged to take advantage of network costs, content availability, reliability objectives, design concerns and component failures. For example, components can be combined onto a single computer or server, or split apart to ensure proper system performance as the system grows. The components can be provided at a single location or distributed to multiple locations throughout the network.

For the purposes of this disclosure, a service provider is a business or organization that provides bandwidth or access to public or private networks such as a local area network (LAN), a wide area network (WAN), or the Internet. Examples of service providers include telephone companies, cable companies, satellite television companies, hotels, hospitals, airlines, airports and schools, among others.

The system 1 illustrated in the example of FIG. 1 is divided into a three-tier architecture that includes a service tier 3, a delivery tier 5 and a subscriber tier 7. The service tier 3, which includes a video plant 2 and a management center 4, generates and provides program data and content to be used by a subscriber in the subscriber tier 7. The term content, as used herein, refers to any video, audio or multimedia content provided by video plant 2 and includes, for example, television programming, movies, video-on-demand, music, and audio broadcasts. The term program data, as used herein, refers to any information provided to set-top boxes 30 in the subscriber tier 7 from devices in the management center 4 and in the delivery tier 5 and includes, for example, configuration data, boot data, video or movie metadata, television metadata, program guides, application software, settings data, and decryption keys, among other types of data that are used by the set-top box 30 during operation.

Subscribers in the system 1 can be organized into a layered hierarchy in which each subscriber can have one or more program accounts and each program account can include one or more set-top boxes 30.

In addition to providing program data and content, the service tier 3 also supports the system management, troubleshooting and back-office functions used by the service provider such as: adding, deleting and updating subscribers to the service; adding, deleting, and updating channels and video-on-demand movies; and creating billing records, generating reports and delivering applications. The service tier 3 also is responsible for combining channels, movies and other content into packages called asset groups, and assigning those asset groups to a subscriber, a subscriber's account or a set-top box. Asset groups are collections of assets such as, for example, a television channel, an on-demand movie or game, or audio broadcasts, although other multimedia content may be classified as an asset as well. As an example, the service tier 3 takes a television channel and makes multiple variations or assets out of it. The multiple assets (i.e., channels) then are combined into a package. The service tier 3 also assigns an asset group profile to each set-top box 30 so that the set-top box 30 knows which asset version to consume. Each asset group can have a lifetime which specifies a start and end to its availability. Each asset within a group also can have an specified lifetime, independent of the asset group lifetime.

Operators 6 correspond to the computers or devices that are used by the service provider to interact with the system 1 at the service tier 3, either locally or remotely via a network connection. The operators 6 can access the system either through a JAVA based application or through a web-browser based interface.

The video plant 2 in the service tier 3 is responsible for preparing, storing and manipulating multimedia content that is delivered to set-top boxes 30 in the subscriber tier 7. Content, such as incoming video and audio, is received by the video plant 2 from various sources that include, for example, satellite connections, analog wireline/wireless broadcast television networks, or cable television networks. One or more coder-decoders (CODECs) 10 may be used to decrypt or descramble the incoming video/audio content and convert it to conventional digital video/audio streams as known in the art, including, for example MPEG-2 or MPEG-4. The video plant 2 can also include a video-on-demand (VOD) server 12 that provides on-demand video and audio content from stored media such as an array of hard disks or CDs. Alternatively, the content for the VOD server 12 is loaded from licensed sources from an outside network 8, such as the Internet, through either wired or wireless connections.

The functions and services of the management center 4 in the service tier 3 are split among one or more servers. The subscriber management system application server 14 runs applications and programs that allow one or more operators 6 to add, delete or update subscribers to the IPTV service; provision and allocate channels, channel packages, movies and videos from the video plant 2 into separate information streams; assign the separate information streams to different classifications called “asset groups”; perform maintenance functions for the IPTV system; access and modify billing information from the billing server 15; and assign the set-top boxes 30 or subscriber accounts to the asset group classifications. A subscriber management system database server 16 provides subscriber and service data storage functions in support of the subscriber management system server 14. Together, the servers 14, 16 are referred to as the subscriber management system (SMS) 17. In general, the SMS 17 directs other servers in the management center 4 to send data to set-top box managers 28 in the delivery tier 5. On rare occasions, however, the SMS 17 communicates directly with set-top boxes 30 in response to set-top box inquiries or when a set-top box 30 is in need of maintenance. Examples of set-top box inquiries include transaction requests such as ordering Pay Per View events or renting movies.

The SMS 17 is responsible for grouping content from the video plant 2 according to a set of classifications called “asset groups.” The SMS 17 also assigns the asset group classification to set-top boxes 30 in the subscriber tier 7. The SMS 17, through the set-top box manager 28, sends an “asset group profile” to the set-top box 30. In this way, content can be delivered to set-top boxes in a targeted manner by matching content assigned to a particular asset group to one or more set-top boxes having the same asset group classification. For example, the asset group profile assigned to the set-top box 30 can direct the set-top box 30 to choose, from among five different versions of channel 2, a single version. In some implementations, the SMS 17 can be provided as a single server or distributed across several servers in one or more locations. Alternatively, the SMS 17 can be run in a clustered mode.

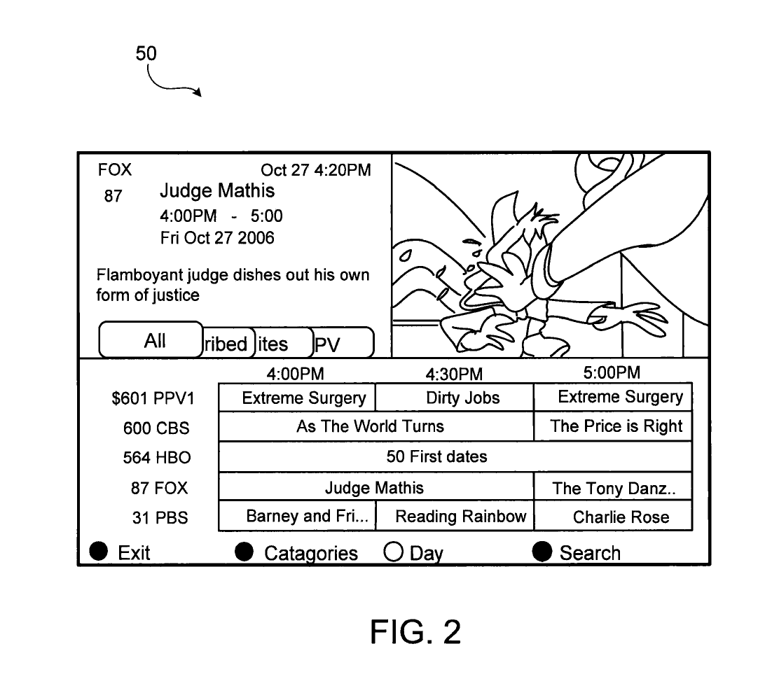

Additionally, the SMS 17 is responsible for defining parameters of a user interface control 50 that is downloaded to a subscriber's set-top box 30. An example screen shot of a user interface control 50 is shown in FIG. 2. The user interface control 50 is a visual guide, such as a button or selection list, running on the set-top box 30 and displayed on an electronic device 31 such as a television set. The user interface control 50 allows users to request or submit data to various pre-loaded applications. The SMS 17 defines the parameters of the user interface control 50 such as the interface appearance, titles, iconography, and audio. Additional user interface control parameters also may be defined by the SMS 17.

In some implementations, the user interface control 50 allows the use of controls called “dynamic buttons.” The set-top box 30 receives information from the SMS 17 that is necessary to form a dynamic button on the screen. This information includes, for example, an index into a library of icons on the set-top box 30, button names and position of the button in a graphical menu. The dynamic button definition includes a template for a universal resource identifier (URL), to which the user is sent upon “pressing” the button. The template also allows the set-top box 30 to fill in the current time, the channel which is currently selected, and a unique set-top box identifier in addition to other parameters. This enables the set-top box 30 to interact with applications in the network through a complete custom user interface without requiring the set-top box to store unique code. Furthermore, dynamic buttons can, in some implementations, eliminate the need to store “cookies.” Instead, the information normally associated with cookies is provided by the set-top box 30 and URL through dynamic information such as the currently selected channel or time. Accordingly, the information provided by the dynamic buttons can change and is not static. The SMS 17 stores a defined user interface template that can for each set-top box 30 that describes the button icons, position and templates for each dynamic button.

Referring again to FIG. 1, other servers in the management center 4 include, for example, a network time protocol (NTP) server 18, a dynamic host configuration protocol (DHCP) server 19, a VOD metadata server 20, an electronic programming guide server 21, a boot server 22 and a portal server 23. The NTP server 18 ensures that components throughout the system 1 are synchronized. The DHCP server 19 provides the initial configuration data for newly installed and activated set-top boxes. The initial configuration data includes, for example, an IP address, time zone information and the address of the set-top box manager 28 to which the set-top box 30 is assigned. Set-top box managers 28 are discussed below. Both the VOD metadata server 20 and electronic programming guide server 21 provide catalog information called “metadata.” The metadata provided by the VOD server 20 relates to information about movies and videos such as movie titles, price, rental period, directors and synopsis although other metadata also can be provided. The metadata provided by the electronic programming guide server 21 relates to information about other content such as television show titles, show times, cast and synopsis. Additional metadata also can be provided by the electronic programming guide server 21. The boot server 22 is responsible for providing the necessary software to load various applications on set-top boxes 30 and can be located at the management center 4 in the service tier 3 or with set-top box managers 28 in the delivery tier 5.

The portal server 23 stores in memory the applications that are delivered to and pre-loaded on subscriber set-top boxes 30. The applications can be developed by the service provider or by third parties and operate in conjunction with the user interface control. The applications may be written using a restricted subset of the programming languages used to create the user interface control, such as HTML and JavaScript and are compiled and loaded onto the set-top box using a boot procedure. These applications include, for example, video games, telephony dialing programs, incoming call notification programs, on-screen voting applications, e-mail messaging programs, and cell phone text messaging programs, among other applications. The applications are launched either remotely from the management center 4 or locally on a set-top box 30 through means of the user interface control 50. To ensure performance and reliability, the applications can be denied access to data, programs and devices such as the electronic programming guide server 21, the VOD server 12, maintenance data structures, and encryption or decryption programs. However, in some implementations, the portal server 23 can provide access to the restricted data, programs and devices upon request by the application.

In addition, the portal server 23 supports application that do not reside in the set-top box 30 but that can be invoked through the use of dynamic buttons without having to reboot the box. The programs and logic for those applications can be downloaded from the portal server 23 by activation of the dynamic buttons. Examples of programs that may not reside on the set-top box 30 include, but are not limited to, applications that ask users to: rate a show that is currently being watched; order food; notify the user of incoming call; display to the user a call history; display to the user a hotel map; and display to the user a bill.

The management center 4 is connected to set-top boxes 30 through a series of network devices known as set-top box managers 28 in the delivery tier 5. The set-top box managers 28 are responsible for controlling the flow of program data and information from the management center 4 and multicasting this information to the set-top boxes 30, as well as responding to requests for data from the set-top boxes 30. In addition, the set-top box managers 28 make sure that applications running on set-top boxes 30 in the subscriber tier 7 have up-to-date information about television programs, shows, movies and other content. Accordingly, when information is needed by a set-top box 30, the set-top box 30 is not required to request it as the information is readily available. Therefore, the response time of the set-top box 30 can be improved.

The number of set-top boxes that can be supported by the set-top box manager 28 depends on memory available, processor speed and whether the information sent to or from the set-top box 30 is encrypted. The manager 28 for a particular set-top box 30 is determined based on an availability index broadcast by each set-top box manager 28. In this way, a set-top box 30 can switch to a backup set-top box manager in the event that a primary set-top box manager ceases to send data or is unavailable. As a result, the reliability of the system 1 can be improved.

As shown in FIG. 1, the STB managers 28 are arranged in a series of STB manager groups 29, in which one or more STB manager groups 29 are provided in the delivery tier 5. For each group 29, a particular STB manager 28 in that group is selected by the SMS 17 as the “master.” Program data from the management center 4 is sent to each master STB manager. The master STB managers, in turn, distribute the data to all the other STB managers 28 in their respective groups 29. In some implementations, a backup “master” also may be selected by the SMS 17 to take over distribution of data in case the master fails. The received program data then is multicast by the set-top box managers 28 to their corresponding set-top boxes 30.

The subscriber tier 7 is the system layer that delivers program data and multimedia content directly to each subscriber through the use of the set-top box 30. Multimedia content and program data received by the set-top box 30 are decrypted, decompressed, and converted to video or audio signals that can be used by an electronic device 31, such as a television, computer or telephone. Alternatively, the multimedia content and program data can be stored in the set-top box memory for the subscriber to interact with at a later time.

Multimedia content from the video plant 2 is multicast directly to the set-top boxes 30, whereas program data from the management center 4, such as programming guides, metadata, initialization and boot data, is first sent to set-top box managers 28 before being multicast to the set-top boxes 30. Connections from the set-top box 30 to set-top box managers 28, the video plant 2 and an outside network 8 are enabled by an access device 32, such as a broadband modem, and an access network 34. The access network 34 includes any broadband network and includes, for example, a digital subscriber line, optical fiber or wireless network.

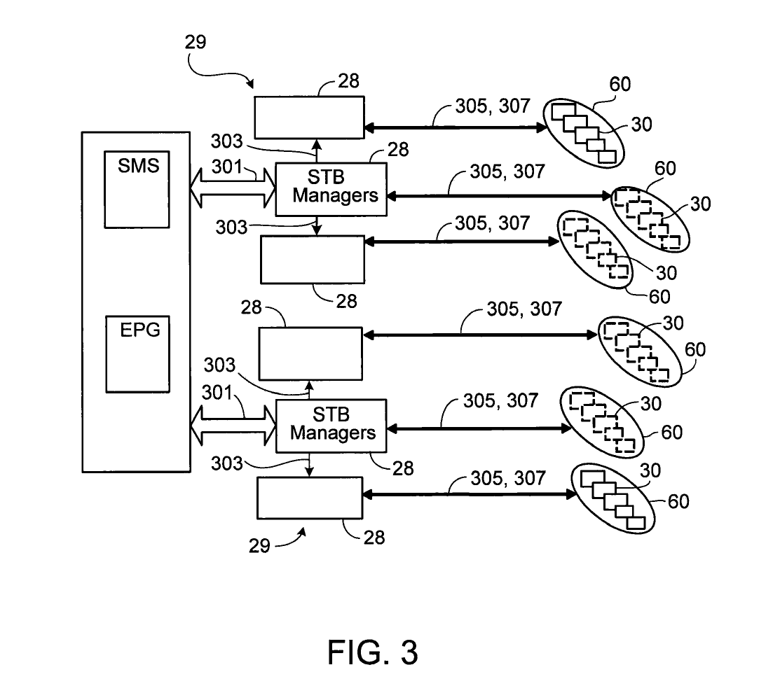

The block diagram of FIG. 3 illustrates how program data and requests are transferred among the management center 4, the set-top box managers 28 and the set-top boxes 30. The management center 4 sends (301) program data to the master set-top box manager in each set-top box manager group 29. This program data includes, for example, application software, configuration data and metadata related to television shows, movies and videos. Other program data also may be sent to the set-top box managers 28 from the management center 4. The program data comes from various sources in the management center 4 including, for example, the SMS 17, the VOD metadata server, the electronic programming guide server 21, and the portal server 23.

Each master set-top box manager distributes (303) the received program data to other set-top box managers 28 in their respective groups 29. The program data is then segmented, compressed, encrypted and continually multicast (305) by the set-top box managers 28 to clusters 60 of set-top boxes 30 according to a bandwidth and priority schedule established by the SMS 17 and the set-top box manager 28 sending the program data. Multiple multicast data streams can be offered by each set-top box manager 28. For example, a set-top box manager 28 can offer multicast streams directed towards television program guide updates, video metadata updates, or game catalog updates. Other multicast streams can be offered as well.

In contrast to the other servers of the management center 4, the boot server 22, which can be located in the management center 4 or in the delivery tier 5, multicasts data to set-top boxes 30 without going through the set-top box manager 28. In particular, the boot server 22 multicasts encrypted images of software programs and applications, which are necessary for starting or “booting-up” set-top boxes, over multiple streams.

To obtain the data offered by the multicast streams, a set-top box 30 sends (307) a request over the access network 34 to join one or more multicast groups offered by the set-top box managers 28 and the boot servers 22. Once the set-top box 30 has joined a multicast group and downloaded the necessary program data, the set-top box then leaves that group. A set-top box 30 can join a multicast group under several different implementations based on information provided by the set-top box manager 28, management center 4, or based on actions and events which occur in the set-top box 30. In a first implementation, the set-top box 30 automatically joins one or more multicast groups from the boot server 22 upon start-up. In some implementations, the set-top box 30 joins these multiple multicast groups in succession according to the features necessary for various applications running on the set-top box 30. This booting sequence ensures that the set-top box 30 boots quickly and delivers service without having to wait for all of the software programs to load. By multicasting the boot data, there is minimal load exerted on other set-top boxes such that many set-top boxes can boot at one time.

In addition to the boot server 22, the set-top box 30 can automatically join multicast streams offered by the set-top box manager 28 upon start-up. In this way, the set-top box 30 can be pre-loaded with all the program data, permissions, settings, decryption keys, screens and catalogs necessary for the applications stored on the set-top box to function correctly. Furthermore, the set-top box 30 can incrementally update the information by rejoining the multicast streams at later times.

In some implementations, the set-top box 30 joins multicast streams based on the relevance or timeliness of currently stored data. For example, if a user is viewing a television program guide for a time period that includes the next six hours, the set-top box 30 checks to see if the currently stored programming data is valid for that time period. If it is valid, the set-top box then checks to see if the data is current, i.e. that the data includes the most recent updates. If the set-top box 30 determines that the data is not current, the box 30 sends a request to join a multicast group that provides valid program and current guide information. The checks and updates can occur continuously in the background during operation of the set-top box 30, independently of the user actions. In this way, the set-top box anticipates the action of the subscriber such that data is preloaded into the set-top box before the subscriber actually requests it. Accordingly, the response time of the set-top box 30 can be increased. In addition to checking data for validity and timeliness, the set-top box 30 can join multicast streams in response to other application requests.

In some implementations, the set-top box 30 joins multicast streams during scheduled updates. The update schedule for set-top boxes 30 can be coordinated so that data for the near term (e.g., a channel guide for the next four hours), is downloaded more often than data for the far term (e.g., a channel guide covering a time period beyond the next four hours). Accordingly, the set-top boxes 30 in the present system can access data that it needs in the near term without having to wait for a complete update of data to be received. In addition, the set-top box 30 can be scheduled to join multicast streams as periods of the day when there is low network usage, such as between 2 and 5 AM. By pre-loading or incrementally updating data, the set-top box 30, in some implementations, can continue to operate even if the servers at the management center 4 crash or fail.

Furthermore, an operator 6 can send data from the management center 4 to the set-top boxes 30 on demand. For example, upon request from an operator 6, the SMS 17 can instruct the master STB managers to download data from a server in the management center 4 and then distribute and multicast the downloaded information to set-top boxes 30. The set-top boxes 30 can be notified by the managers 28 to join the multicast groups and download the necessary information.

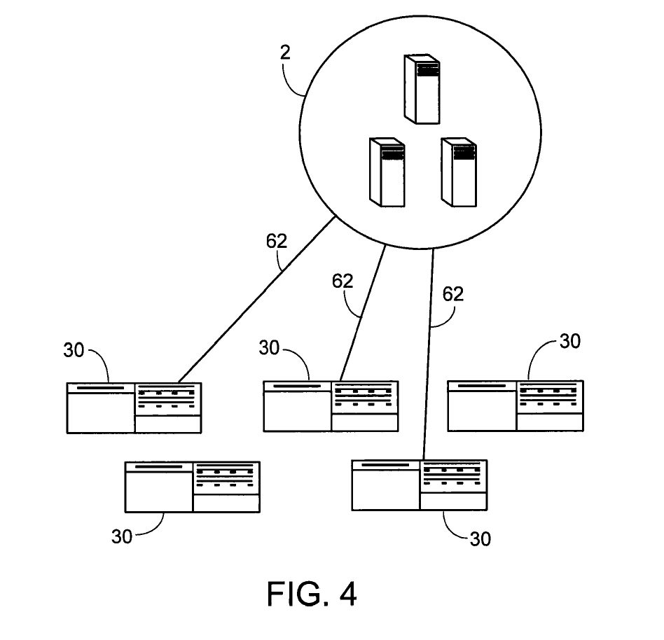

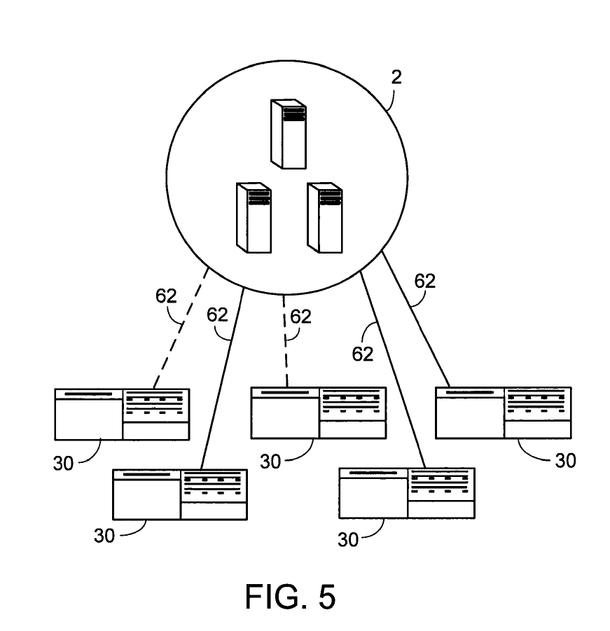

The block diagram of FIG. 4 illustrates sending multimedia content from the video plant 2 to the set-top boxes 30. Multimedia content is sent as multicast streams 62 that can include combinations of different television channels, movies, music and video broadcasts. Content is allocated to the multicast streams according to different classifications called “asset groups.” The asset groups may be associated with parameters such as the content encoding type, different subscriber packages offered by the service provider or demographic information. The asset groups may be associated with other parameters as well. As an example, a video plant sends out two multicast streams 62 (see FIG. 5) assigned to a first and second asset group 64 (dashed line in FIG. 5), 66 (solid line in FIG. 5) in which each asset group is associated with a different type of digital encoding. The multicast stream 62 assigned to the first asset group 64 includes broadcasts of five different television channels encoded in high definition. In contrast, the multicast stream 62 assigned to the second asset group 66 includes broadcasts of the same five television channels encoded in standard definition. The allocation of multimedia content to the different streams 62 is handled by the SMS 17.

The SMS 17 also assigns asset groups to the set-top boxes 30. Asset groups are assigned to a set-top box 30 based on, for example, a subscriber's television package, demographic information, consumer account information, information obtained from an inquiry presented to a user, consumer transactions recorded from the set-top box 30, geographic information or any combination thereof. Asset groups can be assigned based on other parameters as well.

In this way, a set-top box 30 determines which multicast stream 62 to join by looking for a stream 62 having the same asset group classification. For example, FIG. 5 shows several set-top boxes 30 assigned to the first asset group 64. Accordingly, those set-top boxes 30 join the multicast stream 62 that also is assigned to the first asset group 64 and subsequently receive high definition television broadcasts. The set-top boxes 30 that are assigned to the second asset group 66, on the other hand, join the multicast stream 62 that is associated with the second asset group 66 and subsequently receive standard definition television broadcasts. Therefore, by associating multicast content streams with asset groups, the service provider can, in some implementations, target multimedia content to specific subscribers or set-top boxes. Furthermore, multicasting asset groups eliminates the need for a service provider to distribute multiple copies of data and content across the network. As a result, in some implementations, the amount of network bandwidth that would otherwise be required to unicast content to each separate set-top box 30 is reduced. Moreover, additional set-top boxes 30 can be added to the system 1 without degrading network performance.

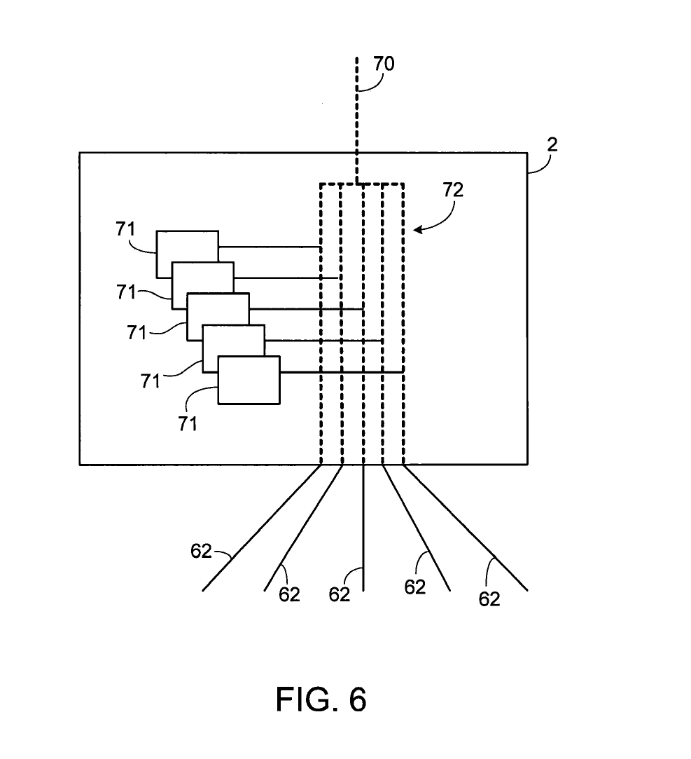

In some implementations, the service provider can interleave additional multimedia content, such as television commercials or advertisements, into the original television broadcasts, movies, music or videos at the video plant 2. The resulting modified content then can be grouped into multicast streams and assigned to asset groups based on the interleaved multimedia content. For example, FIG. 6 shows an unmodified television signal 70 entering the video plant 2 in which the television signal corresponds to a channel from a broadcast network. Advertisements 71 then are interleaved into copies 72 of each signal 70. The interleaved advertisements 71 can be added to the copies 72 so that no original content is lost or replaced. Alternatively, the advertisements 71 can be inserted in place of the original content. The copies 72 then are grouped into multicast streams 62 which may include other multimedia content. The multicast streams 62 then are assigned to asset groups based on the type of advertisement inserted into the original multimedia content. The added content is not restricted to advertisements and can include other multimedia such as additional video or audio clips. Furthermore, the multicast streams 62 can be assigned to asset groups based on parameters other than the advertisements or content inserted into the original broadcasts.

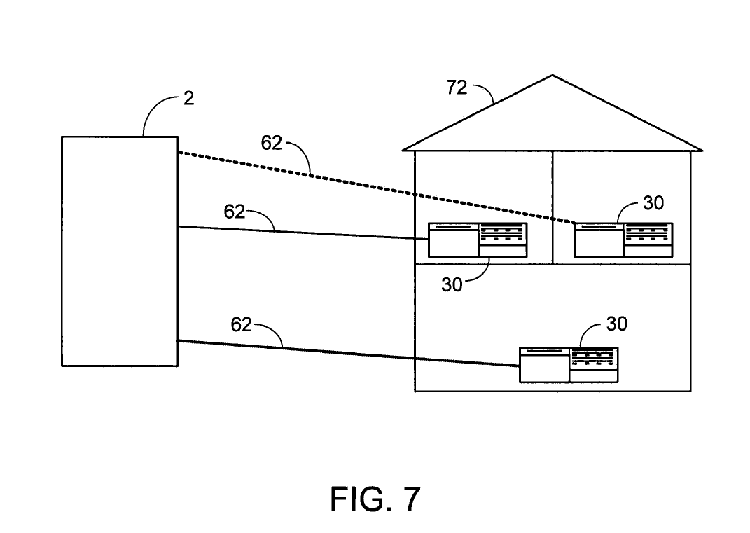

As before, a set-top box 30 then joins a multicast stream 62 according to its assigned asset group. In this way, advertisements can be targeted to specific set-top boxes or subscribers. For example, FIG. 7 shows multiple set-top boxes 30 in a house 72, each of which is assigned to a different asset group. Accordingly, each set-top box 30 joins a different multicast stream 62 available from the video plant 2. Although each stream 62 includes the same group of television channels, the interleaved advertisements are different. As a result, each set-top box 30 in the house 72 can be tuned to the same channel but show different advertisements.

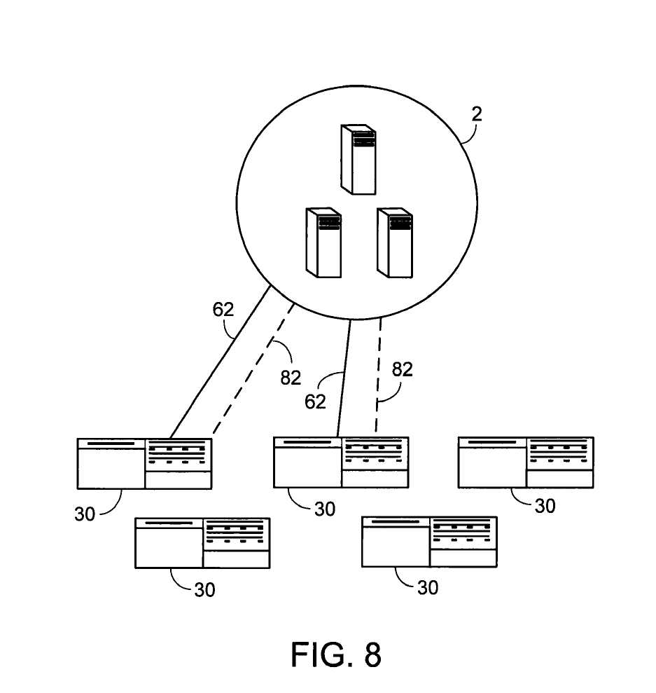

In some implementations, the interleaved multimedia content can be pre-stored in the memory of a set-top box 30 and inserted once the original multimedia content has been received. In this case, the video plant 2 provides one or more additional multicast streams 82 that include the content to be interleaved (see FIG. 8). As with multicast streams 62, the additional multicast streams 82 also can be assigned to asset groups. In contrast, however, it is not necessary for the set-top box 30 to continually receive the data that is included in the multicast streams 82. Instead, the set-top box 30 can download the necessary data and then terminate the feed. Once the content is downloaded by the set-top box 30, it can be interleaved with the received broadcasts. The set-top box 30 can determine where and when to interleave multimedia content based on markers or event triggers in the received broadcasts.

Targeted IPTV

In addition to providing the basic entertainment services discussed above, the IPTV system also enables the delivery of targeted television advertising and content to specific subscribers, accounts, set-top boxes and individuals. Targeting advertisements and content entails collecting information about one or more consumers including, for example, the consumer's demographic, lifestyle behavior and buying behavior, and then selecting and displaying advertisements to that consumer based on the collected information.

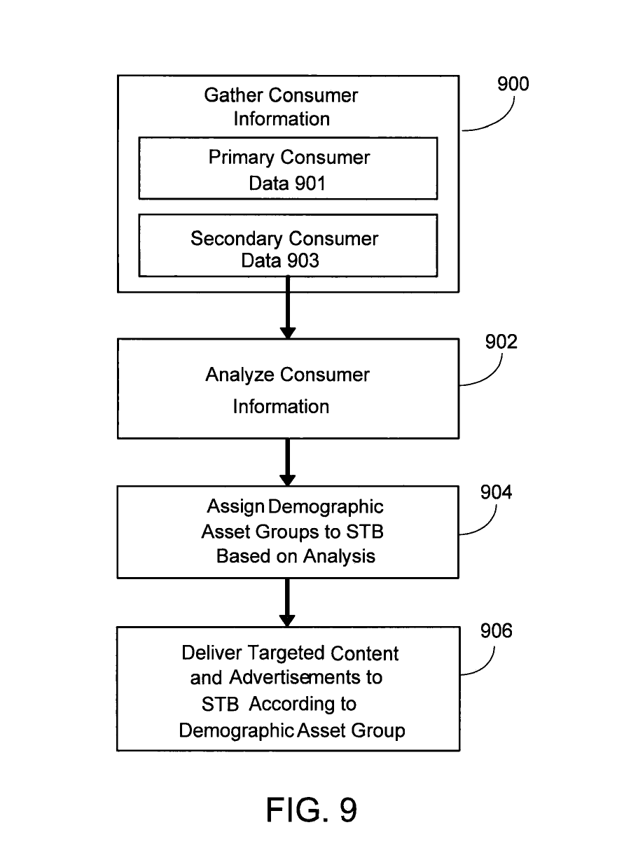

An example of a way to conduct targeted television advertising is illustrated in FIG. 9 and includes the following: gathering consumer information 900; supplying the consumer information to the SMS 17 for analysis 902; based on the analysis of the consumer information, assigning each set-top box to a specified consumer demographic classification called an “demographic asset group” 904; and delivering targeted advertisements to each set-top box according to its specified asset group 906.

The consumer information is gathered by both the set-top box and by the SMS 17 and is divided into two alternative types: primary consumer data 901 and secondary consumer data 903. Once the primary and secondary consumer data 901, 903 are collected, they are stored in secure databases in the SMS 17. Storing the consumer data in a secure database can help prevent unauthorized disclosure or modification of the information which could otherwise lead to identity theft.

Primary consumer data 901 corresponds to consumer demographic information obtained through the STB 30 and includes, for example, the buying habits of the viewer, lifestyle habits of the viewer, and information relevant to the television watching habits of the viewer schedule. The primary consumer data 901 may be collected directly from the consumer, by means of an interactive survey that the STB 30 presents to a subscriber upon installation, as well as indirectly by tracking viewer habits. However, other methods for collecting the primary consumer data 901 also can be used.

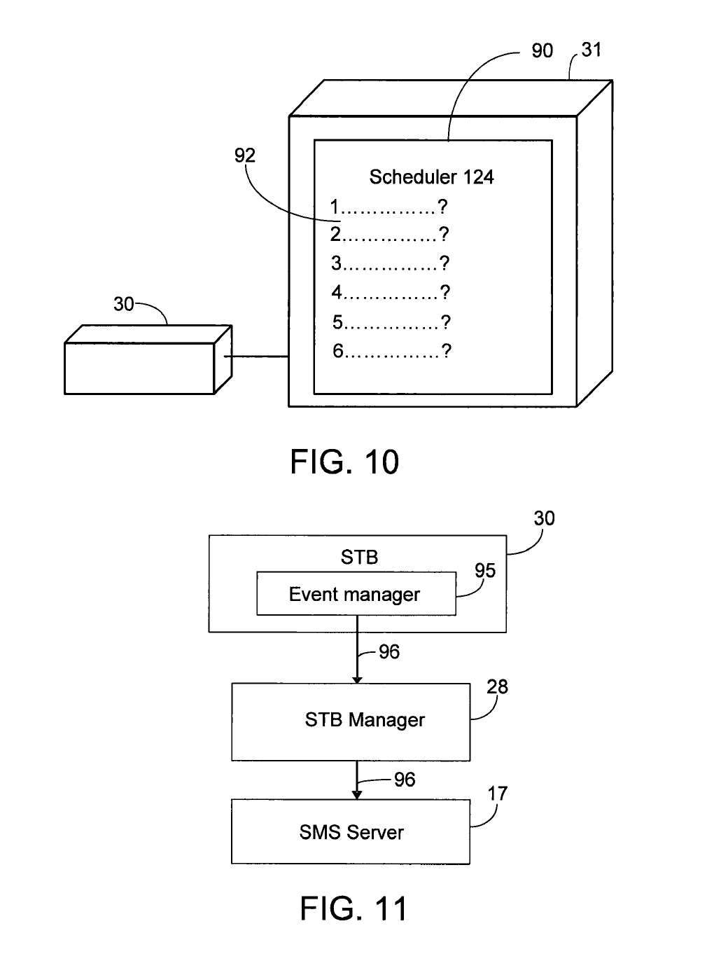

During direct collection of primary consumer data, the STB 30 displays an interactive survey 90 on a television set 31 or through a computer by means of an on-screen questionnaire 92 (see FIG. 10). In some cases, multiple set-top boxes are installed in a single location, such as different rooms in a home. In those circumstances, a separate survey may be provided by each set-top box. The questions contained in the survey relate to, for example, consumer viewing habits, buying habits, lifestyle behavior, as well as other demographics. In addition, the survey may be presented to the consumer periodically, such as semi-annually, annually or bi-annually, so that the consumer information can be updated over time. As a means to encourage completion of the survey, incentives can be offered to the consumer. For example, the consumers may be offered free television, internet, or phone service for a specified period of time, free movie rentals, discounts on services and programs, discounts on program packages, discounts at local businesses, or free gifts. Other incentives may be offered as well.

Indirect collection of consumer information is achieved by recording parameters that identify, for example, the demographic category of the content watched by the consumer, the user profile, the event which occurred on the set-top box 30 and the period during which the event occurs. These and other parameters recorded by the set-top box 30 are collectively called “event markers.” As a piece of content is consumed, a software program in the set-top box 30 known as the event manager 95, collects the event markers and sends them in a message 96 to the set-top box manager 28, which then forwards them to the SMS 17 (see FIG. 11). For example, the collected event markers can identify that a user changed a channel to watch a particular piece of content for 5 seconds in which the content corresponds to a specified demographic type and the user corresponds to a specified user profile. Other events, such as the purchase of video-on-demand movies, also can be recorded by the event manager 95 and forwarded to the SMS 17 for billing purposes.

Event markers that report demographic information are called demographic event markers and can be included as part of the content metadata delivered to the set-top box 30 by the set-top box manager 28. For example, each piece of multimedia content that is consumed by a user can be associated with metadata that specifies a particular demographic category, such as demographic type 1, demographic type 2, etc. The different demographic categories correspond to demographic information such as lifestyle, age, and purchase behaviors. In this example, demographic type 1 may be associated with consumers who are in the 25-30 age range and live in a city whereas demographic type 2 may be associated with consumers who are in the 55-60 age range and live in suburban areas. Other demographic associations may be used as well.

Event markers that correspond to the user profile are called user event markers. User event markers help the SMS 17 distinguish each user from one another. The user event markers either identify different consumers or identify a demographic category to which the consumer is assigned by the SMS 17. Other event markers include, but are not limited to, how long content is watched, the time of day the content is watched, and the current date.

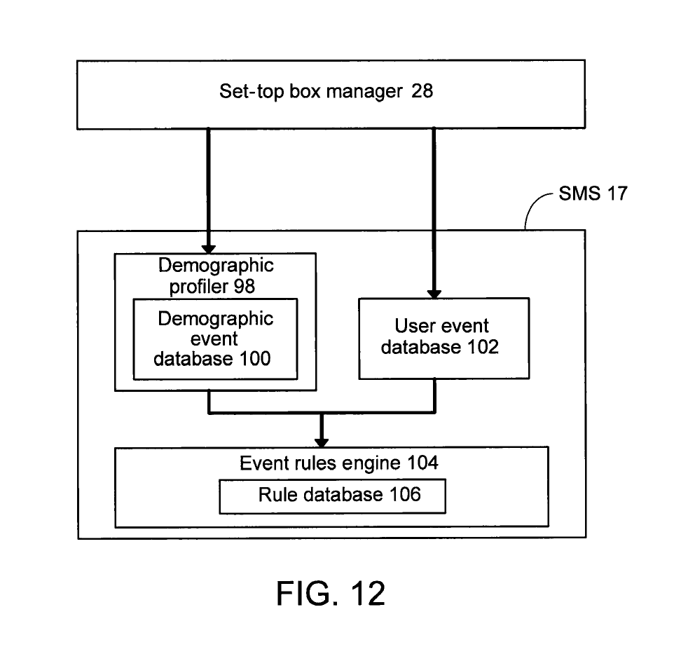

Upon receiving the demographic event markers, the set-top box manager 28 groups them together and forwards the grouping to a software engine in the SMS 17 called the demographic profiler 98 (see FIG. 12). The demographic profiler 98 records the event markers and subsequently updates a database in the SMS 17 called the demographic event database 100. The demographic event database 100 is a categorized and weighted listing of demographic profiles of users. The weighting of each profile indicates how relevant a particular demographic category is to a specified user. As event markers for a particular user are received, the profiler 98 serves to change the weighting of the demographic profile assigned to that user.

Similarly, user event markers are received and processed in a user event database 102 in the SMS 17. Each user event database 102 can be associated with a particular subscriber which includes all of the subscriber's accounts and set-top boxes 30. Alternatively, the user event database 102 can be associated with a particular subscriber account or a particular set-top box 30.

The combination of values from the user event database 102 and the demographic event database 100 then are forwarded to a processing engine in the SMS 17 called the event rules engine 104. The event rules engine 104 analyzes the received values and directs the SMS 17 to take a specific action based on a database of rules 106. For example, the event rules engine 104 can direct the SMS 17 to assign an entity (i.e., a subscriber, an account or a set-top box 30) to an asset group or change the entity's preexisting asset group assignment. Additionally, the event rules engine 104 can direct the SMS 17 to change values in one or more databases stored by the SMS 17, send a particular event for processing elsewhere in the system 1, or add a record into a database for processing by the event rules engine 104. The event rules engine 104 can act in response to other data as well, including, for example, the time, date, day of the week, the state of the set-top box 30, and the state of the subscriber's account. The event rules engine 104 also can direct the SMS 17 to decrement values in the demographic event database 100 and the user event database 102 to allow the continual addition of values.

The event rules engine 104 can be scheduled to run at set times or run continuously to ensure up-to-date user and demographic profile information. The event rules engine 104 also serves to enable or disable rules, create and load new rules, as well as inspect and delete rules in the rule database 106.

The entries to the demographic event database 100 and the user event database 102 can be created, updated or deleted by operators 6 manually or automatically using software programs stored in the SMS 17. The database entries can be modified in response to user surveys or by correlations between a subscriber's address information and third party databases. The demographic event markers and user event markers can be recorded in the set-top box 30 in response to consumption of any multimedia content including, for example, live television channels, pay per view events, content stored and consumed on a set-top box based digital video recorder, content stored and consumed on a network based digital video recorder, launching of applications from the set-top box 30, commercials inserted into the content, invocation of web browser web pages, or by an application itself. By assigning event markers to content/advertising and recording the event markers in response to consumption, it is possible to profile users without the use of cookies and without intrusion. Furthermore, the use of event markers allows user profiling independent of the media being consumed, i.e., the profiling is based on demographic information and not the specific content such as which particular channel is being viewed.

In addition to recording event markers, the event manager 95 in the set-top box 30 assesses whether a user is actually watching television by monitoring set-top box events within a specified window of time at content boundaries or following activation of a menu or application. Set-top box events include, for example, whether the set-top box is on, whether a channel has been changed, whether the user has selected or is navigating through the user interface control 50 (see FIG. 2), volume control and whether any other guides of the set-top box have been selected. An example of a content boundary is at the start or end of a television program. Knowing whether a user is watching the television allows the SMS 17 to measure the number of viewers of content and advertisements. Accordingly, the service provider or advertisers can evaluate the reach of their media.

In contrast to primary consumer data 901, the secondary consumer data 903 corresponds to statistically derived demographic, lifestyle and behavior information. The secondary consumer data 903 is obtained from one or more market segmentation databases. A market segmentation database divides a market into distinct subsets or segments that behave in the same way or have similar needs. In particular, a market segmentation database may divide a group of households or neighborhoods within a specified region into a number of unique demographic clusters, in which each cluster is associated with certain likes, dislikes, lifestyles and purchase behaviors. For example, one cluster may be associated with consumers who are in the 25-30 age range, live in a city, have a relatively low household income, and prefer to spend week nights out of the home whereas another cluster may be associated with consumers who are in the 55-60 age range, live in suburban areas, have a relatively high household income, and have a preference for travel. Other clusters may have additional and different demographic associations.

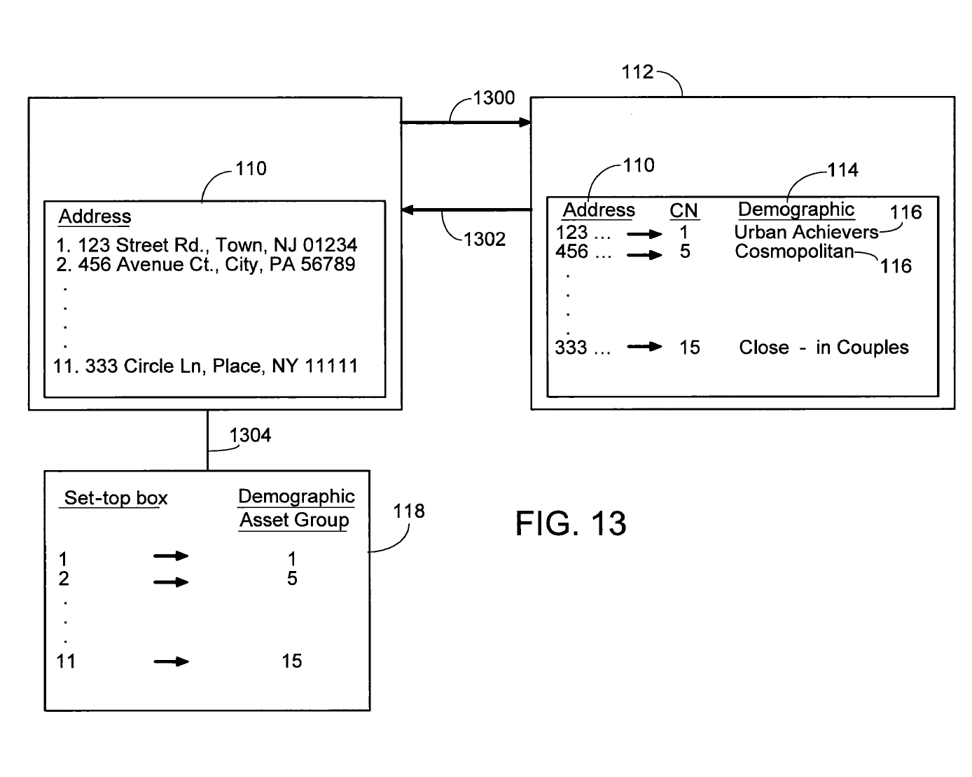

An example of a way to obtain secondary consumer data 903 is shown in FIG. 13. The service provider submits at (1300) the consumer's home address 110 to a marketing information source company 112 which specializes in market segmentation databases. As new customers are added to the service provider's system, the customer addresses 110 can be sent to the source company 112 by means of an automated batch process from the SMS server 17. The marketing information source company then associates each household address 110 to one of N different demographic clusters 114 as defined by the market segmentation database, wherein each demographic cluster is identified by a corresponding cluster number CN. Each cluster 114 may also have a label 116 that succinctly identifies the demographic with which the address is associated. The information generated by the marketing information source company, including the cluster numbers CN for each address and the relevant demographic information, is then returned at (1302) to the service provider.

The service provider also may license the market segmentation databases and assign cluster numbers CN itself. Alternatively, in some implementations, the service provider may assign cluster numbers CN to households from market segmentation databases that the service provider has generated. The total number N of different defined demographic clusters is not fixed and can vary according to the provider of the market segmentation database.

In some implementations, the SMS 17 then assigns at (1304) each set-top box 30 to a demographic asset group 118 based on the cluster information. In particular, the demographic asset group 118 identifies the demographic cluster to which the set-top box 30 belongs. For example, if the SMS 17 determines that a household address belongs to the 45-50 age demographic (e.g., denoted by cluster number 4), then one or more subscribers, program accounts, or set-top boxes 30 located at that same address is assigned to demographic asset group number 4. By assigning a demographic asset group 118 to each set-top box 30, the SMS 17 can target viewers with specialized advertisements or content that corresponds to the same asset group 118.

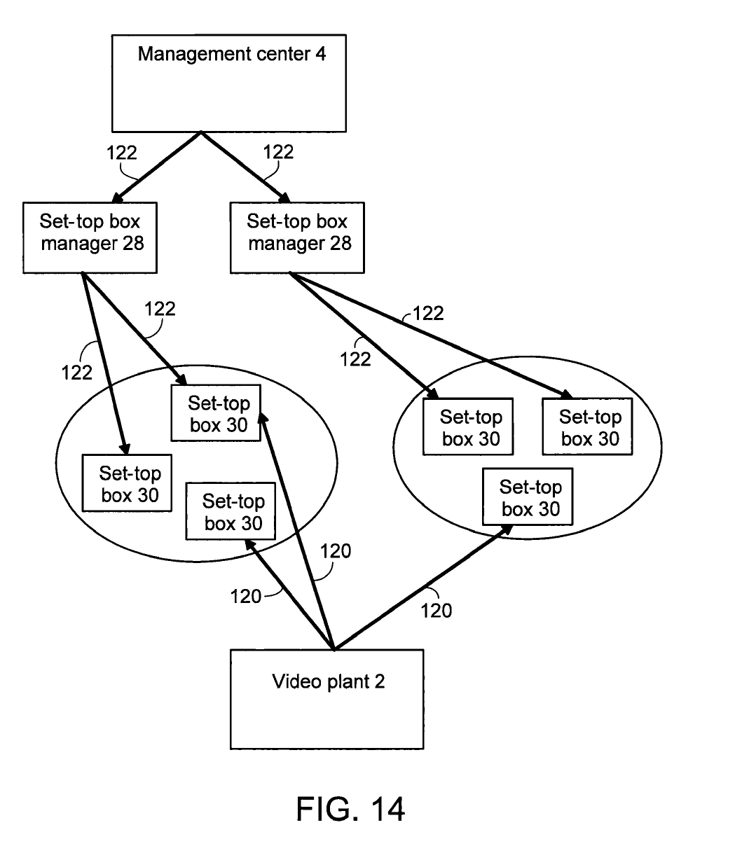

Alternatively, in some implementations, the SMS 17 assigns demographic asset groups 118 to subscribers, accounts or set-top boxes 30 based on both the primary and secondary consumer information 901, 903. In this way, advertising and content can be targeted and delivered down to an individual consumer level. The delivery of targeted content, as illustrated in FIG. 14, includes sending targeted multimedia streams 120 from the video plant 2 and interactive overlays 122 from the management center 4.

Multimedia streams 120 correspond to broadcasts of videos, movies, music, television channels, advertisements and other content in which each stream 120 includes some or all of its multimedia targeted towards a specific demographic category. The streams 120 are constructed by interleaving targeted content with original broadcast streams or by inserting the targeted content in place of the original broadcast content. To determine how the content is allocated to the different streams, the SMS 17 uses information obtained from the event rules engine 104 (see FIG. 12), the customer (e.g., the package of channels and content they wish to purchase), subscriber settings, the content's attributes (e.g., a demographic event marker assigned to the content); and secondary consumer information 903. After forming the different multimedia streams 120, the SMS 17 assigns each stream 120 to a particular demographic asset group 118 based on the demographic categories of the content and advertisements contained therein.

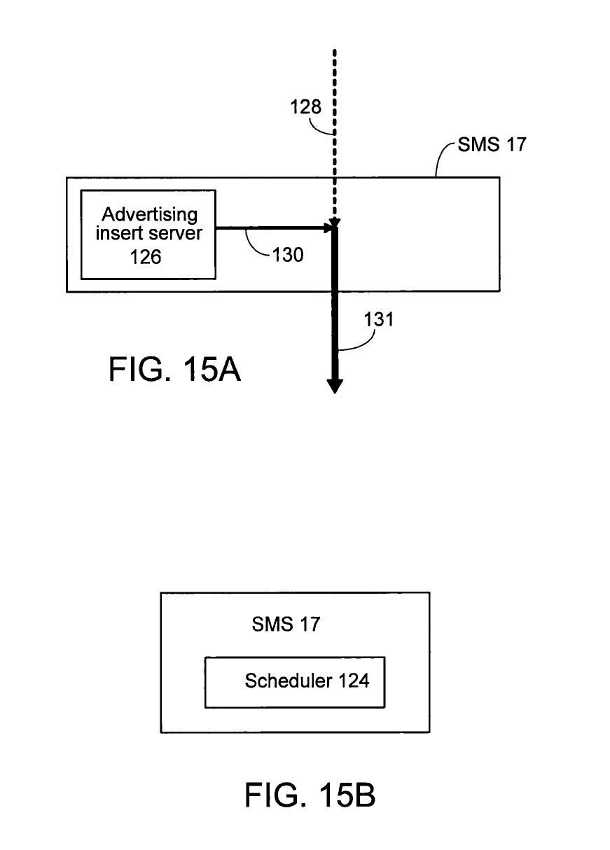

Targeted content such as advertisements are inserted into original broadcast streams using an advertising insert server 126 which can be stored either at the management center 4 or at the video plant 2. The advertising insert server 126 takes original multicast or unicast streams 128 of video, audio or data and, upon certain specified triggers, replaces or appends the video, audio or data content with advertising content 130 to provide content streams 131 that include targeted advertising (see FIG. 15A). The advertising content can be stored locally at the video plant 2 or remotely on the network. The triggers can be based on the content itself (e.g. content boundaries which include the start and end of a program or commercial breaks), time, or commands issued by the SMS 17 or other servers.

Accordingly, the IPTV system can offer content streams which incorporate content targeted to specific demographic groups. For example, in some implementations, the advertising insert server 126 can take an original television channel broadcast and create different versions of the channel, each with advertisements targeted towards a different demographic group. The SMS 17 then assigns each of the different channels to a different demographic asset group 118 based on the advertisements incorporated therein. The resulting channels then are multicast to set-top boxes 30, although the channels may be unicast as well. If a set-top box 30 is assigned to a demographic asset group 118 that matches one of the channels, the set-top box 30 joins that multicast channel and consumes the content and advertisements. In other implementations, the targeted content can be downloaded and pre-stored on the set-top box 30 and inserted into the multicast channel at a later time. The pre-stored content can be distributed at defined times (e.g., daily or weekly), sent in multicast or unicast streams, and disabled or deleted from storage to create disk space for additional content. The disabling or deletion of content can be a scheduled event, based on the number of times the content is viewed, or based on other parameters set by the set-top box 30 or SMS 17.

The interactive overlays 122 are graphical presentations which can be displayed on top of content, replace content or inserted between content. Alternatively, the overlays 122 can be audio only, a graphical display and audio, controls or any combination thereof. The overlays 122 are multicast or unicast from the set-top box manager 28 and also can be targeted to specified demographic categories. In some implementations, the overlays 122 are pre-stored on the set-top box 30 and combined with the multimedia content as it is received. In other implementations, the overlays 122 can be loaded dynamically from a server in the network such as the set-top box manager 28.

The overlays 122 display information and controls such as virtual buttons, drop down lists, icons, etc that are selectable from the set-top box, remote control or associated keyboard. User activation of one or more of these controls can generate new displays, send requests for more information to the SMS 17, activate applications, record polling information or allow a user to engage in e-commerce, access e-mails, access billing statements and use other services. As an example, controls in the overlay 122 include buttons labeled with text that reference advertisements or content such as “send me more information,” “buy now,” “I'm not interested,” “I like this show,” or “I like this actor.” The overlays are designed by the service provider, advertiser or other third party and are stored in the application servers in the management center 4 prior to distribution. The overlays 122 can be implemented using programming languages such as HTML and JavaScript.

Similar to the targeted content, the set-top box 30 launches or displays each overlay 122 in response to events called triggers. Examples of triggers include, but are not limited to, messages from the SMS 17 (e.g., emergency warnings), specific user events (e.g., changing a channel or launching a web browser), or the content boundaries (e.g., the beginning or end of a program). Overlays 122 also can be launched as a scheduled event in which the schedule is specified by the set-top box 30. An advantage of storing overlays 122 in the set-top box 30 is that, in some implementations, there is no network delay associated with displaying the overlays 122 on top of the multimedia content.

The SMS 17 also includes a program engine called a scheduler 124 (see FIG. 15B) that determines how the set-top boxes 30 should receive the overlay 122 (i.e., unicast or multicast), when the overlays 122 should be loaded onto set-top boxes 30, what controls in the overlay 122 are allowed, and when the overlays 122 are “retired.” Retirement of overlays 122 corresponds to deleting or disabling overlays 122 stored in the set-top box 30 or on the application server. Overlay retirement can occur at particular times specified by the scheduler 124 or based on a policy, such as the number of times an overlay is viewed. In some implementations, the overlay 122 includes software parameters that instruct the set-top box 30 to retire the overlay 122, prevent the use of certain functions while the overlay 122 is displayed (e.g., fast-forward, rewind, pause, stop, skip to another application), prevent the invocation of one or more buttons, or limit the hours that the overlay 122 is displayed.

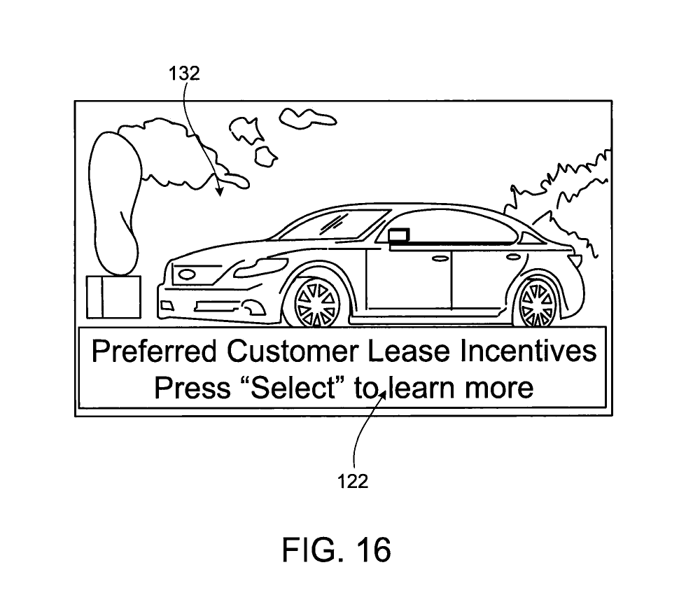

An example of an interactive overlay 122 is illustrated in FIG. 16. In that example, the overlay 122 is displayed as a text graphic that covers approximately ⅙ of the lower portion of a television screen and is launched to coincide with the display of the underlying advertisement 132. In some implementations, the trigger event for the overlay 122 is a demographic marker of the underlying content such. Accordingly, it is possible to present an overlay 122 that is related to the underlying content. For example, if the video advertisement displays an ad for a local car dealer, the interactive overlay 122 may offer a discount on oil changes at the same local car dealer. In order to obtain the discount, the viewer would select the action button highlighted in the overlay 122 at which point the viewer would be forwarded to a web page where the viewer can enter information to receive the discount or otherwise view details regarding the product. Alternatively, in response to selecting the action button, the STB can record the action and submit a request for the discount on behalf of the viewer automatically. The request can be processed by the SMS server 17 or by the STB manager 28 depending on the implementation.

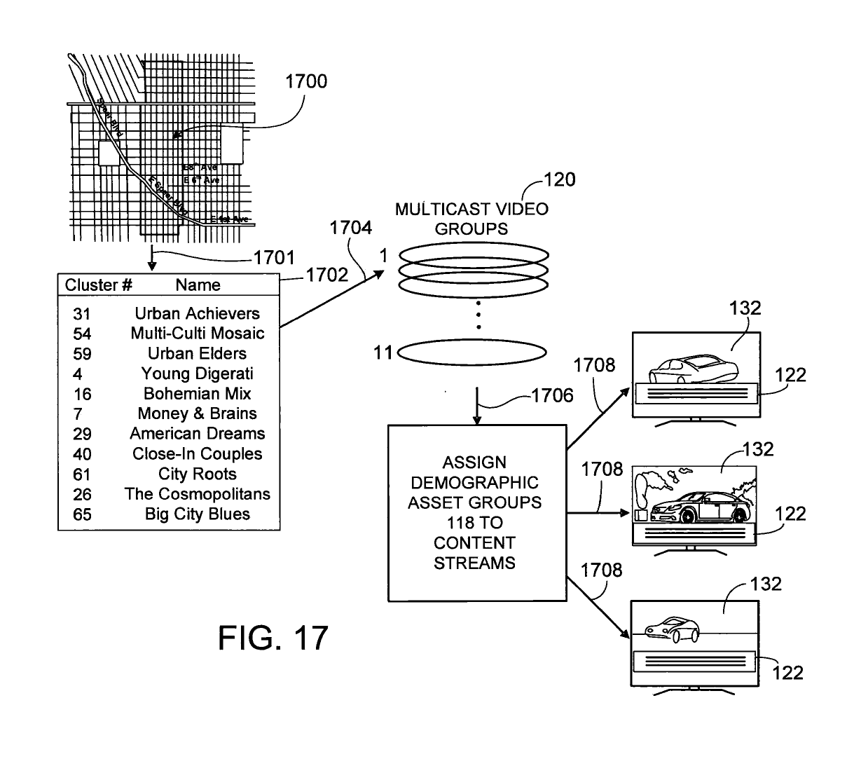

To determine the total number of targeted content streams 120 to be used in the IPTV system 1, the service provider analyzes which demographic clusters constitute a specified percentage of households in a specified area. For each demographic cluster identified, a targeted content stream 120 is assembled and associated with that demographic cluster. FIG. 17 illustrates an example of assigning targeted content streams. As before, the service provider submits customer addresses to a marketing information source company. In return, the marketing information source company provides at (1701) the service provider with a demographic cluster number CN for each address, in which each cluster number CN is associated with a statistically derived lifestyle and buying behavior demographic. Alternatively, the service provider can request the marketing information source company provide segmentation for an entire geographic area, as illustrated by the shaded region of a map 1700 in the example of FIG. 17.

The service provider then analyzes at (1702) the cluster numbers provided by the marketing information source company to determine which demographic clusters constitute a certain percentage, for example 90%, or more of the households in the service provider's network. In the example of FIG. 17, the service provider determines that eleven demographic clusters constitute the specified percentage. In this case, eleven demographic asset groups 118 are generated. Content streams 120 (e.g., multicast video groups) then are generated at (1704), each of which includes advertisements and content targeted towards one of the specified demographic asset group 118. The targeted content streams 120 then are associated at (1706) with each demographic asset group 118 multicast at (1708) to the set-top boxes 30, which, in turn, join the multicast streams 120 based on their assigned demographic asset group 118. As a result, TV advertisements and content can be targeted to specific households or set-top boxes 30 independently of the channel being viewed. Furthermore, by using both the primary consumer information 901, which incorporates individual demographic behavior, and secondary consumer information 903 to assign demographic asset groups 118 to set-top boxes 30, it is possible target the content down to the individual level.

Various aspects of the system may be implemented in hardware, software or a combination of hardware and software. Circuitry, including dedicated or general purpose machines, such as computer systems and processors, may be adapted to execute machine-readable instructions to implement the techniques described above. Computer-executable instructions for implementing the techniques can be stored, for example, as encoded information on a computer-readable medium such as a magnetic floppy disk, magnetic tape, or compact disc read only memory (CD-ROM).

A number of embodiments of the invention have been described. Nevertheless, it will be understood that various modifications may be made without departing from the spirit and scope of the invention. Accordingly, other embodiments are within the scope of the following claims.

What is claimed is:

1. A method of distributing data comprising:
creating one or more groups of assets;
establishing an asset classification for each asset or group of assets;
assigning at least one of the asset classifications to a network device;
assigning at least one of the asset classifications to a first set of data;
transmitting the first set of data over a network that includes the network device; and
receiving the first set of data in the network device if the asset classification assigned to the first set of data is the same as the asset classification assigned to the network device.

2. The method of claim 1 further comprising selecting the first set of data from a first asset or first group of assets.

3. The method of claim 1 wherein an asset comprises multimedia content.

4. The method of claim 3 wherein the multimedia content comprises at least one of a television broadcast, movie, audio broadcast, advertisement, interactive game or communication.

5. The method of claim 1 wherein an asset comprises metadata related to multimedia content.

6. The method of claim 1 wherein an asset comprises software applications configured to run on the network device.

7. The method of claim 1 wherein an asset comprises initialization or configuration data for the network device.

8. The method of claim 1 further comprising transmitting the first set of data as part of a multicast data transmission.

9. The method of claim 1 further comprising assigning one of the asset classifications to the network device based on consumer information.

10. The method of claim 9 wherein the consumer information comprises information related to consumer transactions on the network device.

11. The method of claim 9 wherein the consumer information comprises consumer account information.

12. The method of claim 9 wherein the consumer information comprises information collected from an inquiry presented to the consumer.

13. The method of claim 9 wherein the consumer information comprises demographic information.

14. The method of claim 9 wherein the consumer information comprises any combination of information related to consumer transactions on the network device, consumer account information, information collected from an inquiry presented to the consumer and demographic information.

15. The method of claim 1 further comprising changing the asset classification of the network device based on consumer information.

16. The method of claim 1 wherein creating one or more group of assets comprises:
recording consumer transactions on one or more network devices; and
combining assets into the one or more groups based on the recorded consumer transactions.

17. The method of claim 1 wherein creating one or more group of assets comprises:
collecting demographic information; and
combining assets into the one or more groups based on the collected demographic information.

18. The method of claim 1 wherein creating one or more group of assets comprises:
collecting information from an inquiry presented to a consumer; and
combining assets into the one or more groups based on the collected information.

19. The method of claim 1 wherein the network device stores the first set of data in memory.

20. The method of claim 1 further comprising:
assigning a plurality of asset classifications to the network device; and
receiving additional data in the network device if an asset classification assigned to the additional data is the same as one or more of the plurality of asset classifications assigned to the network device.

21. A system for distributing data comprising:
a communications network;
one or more servers coupled to the communications network, the one or more servers operable to:
create one or more groups of assets; and
establish an asset classification for each asset or group of assets; and
a device coupled to the communications network, the device operable to receive a first set of data transmissions over the communications network if an asset classification assigned to the first set of data transmissions is the same as an asset classification assigned to the device.

22. The system according to claim 21 wherein the first set of data transmissions comprises content from a first asset or first group of assets.

23. The system according to claim 21 wherein an asset comprises multimedia content.

24. The system according to claim 23 wherein the multimedia content comprises at least one of a television broadcast, movie, audio broadcast, advertisement, interactive game or communication transmission.

25. The system according to claim 21 wherein an asset comprises metadata related to multimedia content.

26. The system of claim 21 wherein an asset comprises software applications configured to run on the device.

27. The system of claim 21 wherein an asset comprises initialization or configuration data for the device.

28. The system of claim 21 wherein the device comprises a memory to store the first set of data transmissions.

29. The system of claim 21 wherein the one or more servers are operable to transmit the first set of data transmissions in a multicast transmission.

30. The system of claim 21 wherein the one or more servers are operable to assign one or more asset classifications to the device.

31. The system of claim 21 wherein the one or more servers are operable to create one or more asset groups based on consumer information.

32. The system of claim 31 wherein the consumer information comprises consumer transactions recorded on the device.

33. The system of claim 31 wherein the consumer information comprises demographic information.

34. The system of claim 31 wherein the consumer information comprises information obtained from a consumer inquiry.

35. The system of claim 31 wherein the consumer information comprises consumer account information.

36. The system of claim 31 wherein the consumer information comprises any combination of information related to consumer transactions on the network device, consumer account information, information collected from an inquiry presented to the consumer and demographic information.

37. The system of claim 21 wherein the one or more servers comprise a database storing asset classification information, asset group information and consumer information.

38. An article comprising a machine-readable medium storing machine-executable instructions that, when applied to a machine, cause the machine to:
create one or more groups of assets;
establish an asset classification for each asset or group of assets;
assign at least one of the asset classifications to a first set of data;
transmit the first set of data over a network that includes a network device; and
configure the network device with one of the asset classifications such that the network device receives the first set of data if the asset classification assigned to the first set of data is the same as the asset classification assigned to the network device.

39. The article of claim 38 including instructions that, when applied to the machine, cause the machine to:
transmit the first set of data over the network as part of a multicast data transmission.

40. The article of claim 38 including instructions that, when applied to the machine, cause the machine to:
select the first set of data from a first asset or first group of assets.

41. The article of claim 38 including instructions that, when applied to the machine, cause the machine to:
configure the network device with an asset classification based on consumer information.

42. The article of claim 41 wherein the consumer information comprises information related to consumer transactions on the network device.

43. The article of claim 41 wherein the consumer information comprises consumer account information.

44. The article of claim 41 wherein the consumer information comprises information collected from an inquiry presented to the consumer.

45. The article of claim 41 wherein the consumer information comprises demographic information.

46. The article of claim 41 wherein the consumer information comprises any combination of information related to consumer transactions on the network device, consumer account information, information collected from an inquiry presented to the consumer and demographic information.

47. The article of claim 38 including instructions that, when applied to the machine, cause the machine to:
change the asset classification of the network device based on consumer information.

48. The article of claim 38 including instructions that, when applied to the machine, cause the machine to:
record consumer transactions on one or more network devices; and
combine assets into one or more groups based on the recorded consumer transactions.

49. The article of claim 38 including instructions that, when applied to the machine, cause the machine to:
collect demographic information; and
combine assets into one or more groups based on the collected demographic information.

50. The article of claim 38 including instructions that, when applied to the machine, cause the machine to:
collect information from an inquiry presented to a consumer; and
combine assets into one or more groups based on the collected information.

51. The article of claim 38 including instructions that, when applied to the machine, cause the machine to:
configure the network device with a plurality of asset classifications.
